(19) United States
(12) Patent Application Publication
(10) Pub. No.: US 2021/0038932 A1
(43) Pub. Date: Feb. 11, 2021

(54) FIRE PROTECTION ENCLOSURE

(71) Applicant: Leonard Hutton, Torrance, CA (US)

(72) Inventor: Leonard Hutton, Torrance, CA (US)

(21) Appl. No.: 16/988,937

(22) Filed: Aug. 10, 2020

Related U.S. Application Data
(60) Provisional application No. 62/884,740, filed on Aug. 9, 2019.

(51) Int. Cl. A62C 3/02; A62C 2/06

(52) U.S. Cl. CPC A62C 3/0257; A62C 2/065

(57) ABSTRACT

This disclosure herein may relate to various embodiments of a fire protection enclosure which may utilize a fire suppression blanket made of fire-resistant material. The fire suppression blanket may have a lattice. The fire protection enclosure may further have a frame which may have a first hinge, a second hinge, a first ground frame arm, a first support arm, a second support arm, a second ground frame arm, a first leg, and a second leg and may optionally include an intermediate support arm. There may be any number of intermediate support arm present, dependent on the specific environment of use. Additionally disclosed may be a draw member connected to the first ground frame arm. Additionally disclosed may be a plurality of fire panels made of fire-resistant material and connected together to form a fire cover therein, the fire cover may be reversibly attached to the frame.

This application claims the benefit of U.S. Provisional Application No. 62/884,740 filed Aug. 9, 2019, the contents of which are incorporated by this reference in their entireties for all purposes as if fully set forth herein.

### INCORPORATION BY REFERENCE

U.S. Pat. Nos. 9,486,656 and 9,731,154, the entire disclosures of which, are incorporated herein by reference. In the event of inconsistent usages between this document and those documents so incorporated by reference, the usage in the incorporated references should be considered supplementary to that of this document; for irreconcilable inconsistencies, the usage in this document controls.

### TECHNICAL FIELD

The disclosure herein relates generally to fire protection devices deployable on short notification of incoming fire. More particularly, the disclosure relates to devices and apparatuses to facilitate the rapid deployment of protective devices for objects and human bodies by which a full fire defensible barrier may be placed between an object and/or human body and a fire.

### BACKGROUND

Wildfires are common in western states, for example, California, wherein approximately two million homes and countless more acres of wildlands face extreme wildfire hazards due to proximity to fuels such as trees, grass, and brush.

Current firefighting tactics require intensive coordination as ground and air resources are deployed to fight fires threatening homes and surrounding lands. Ground resources typically include teams or groups of people with firefighting training, who are deployed to dig fire lines in advance of approaching flames. Frequently, wildfires are of such intensity and occur in such strong winds that burning debris blows over the fire line, and subsequent fire lines must be created. This process can occur many times over as ground crews attempt to stay ahead of the fire.

These ground crews face further danger when trying to regulate the burn characteristics of intensely hot wildfires, for example, breaking a wildfire fire line down into a series of uniform individual fires helps control the spread of a fire and prevent flare-ups, or by digging the above-noted fire line. In attempting to stop the burn path of the wildfire, these ground crews place themselves in immense personal danger. The ground crews carry with them personal fire shelters which are commonly constructed of various thermally reflective materials, for example, aluminum or coated and stretched polyester film. At times fatalities occur when the personal fire shelters come into contact with the actual plasma of a flame or embers of a wildfire which results in the melting and failure of the personal fire shelters.

Grasslands, chaparral, and other generally arid areas are prone to hotter and more intense wildfires due to the highly combustible nature of their flora, which serves as a fuel source once ignited. The compounding effects of climate change have further pushed wildfires into forested areas which were previously resistant to hotter and more intense flames common in arid areas. Wildfires burning in such areas are also prone to flare-ups when denser fuel areas ignite simultaneously, resulting in firestorms. Moreover, with an ever-increasing population globally, more and more residences are being built in areas that previously could burn with little risk to life or property.

Accordingly, there are now routine fire risk advisories for residences in these areas, with a wide range of recommendations for homeowners to reduce the risk of fire to property. These include creating a defensible space wherein combustible material is cleared from 100 to 200 feet around a home, installing a hardened roof, sealing entryways from embers, and engaging with community organized fire preparation programs. However, even with these types of precautions, homes built in existing fire zones still run a tremendous risk of burning in the event of a wildfire or residential fire which is uncontrolled.

Therefore, there exists a need for a fire enclosure device which is lightweight, inexpensive, and easy to deploy, which avoids the need for water in order to function. There is also a need for an apparatus, deployable as an enhancement to the personal fire protection bags which ground fire crews carry with them to dig fire lines.

### SUMMARY

This disclosure herein may relate to various embodiments of a fire protection enclosure and a personal fire protection enclosure. The personal fire protection enclosure may comprise a fire suppression blanket made of fire-resistant material. The fire suppression blanket may have a lattice that may define a multiplicity of openings. An upper portion may further have one long side, two short sides, an angled side, and similarly be made of fire-resistant material. Further disclosed may be a lower portion having two long sides and two short sides and made likewise be made of fire-resistant material. The lower portion may further have a fold flap. A coupling strip may optionally be used and may be adapted to connect the fire suppression blanket to the ground portion if so used.

Certain embodiments of a fire protection enclosure may also be disclosed and may utilize a fire suppression blanket made of fire-resistant material. The fire suppression blanket may have a lattice which define a multiplicity of openings. The fire protection enclosure may further have a frame which may have a first hinge, a second hinge, a first ground frame arm, a first support arm, a second support arm, a second ground frame arm, a first leg, and a second leg and may optionally include an intermediate support arm. There may be any number of intermediate support arm present, dependent on the specific environment of use. The first hinge may be in rotatable communication with the first ground frame arm, the first support arm, the second support arm, the second ground frame arm, the first leg, and optionally with one or more than one intermediate support arm. The second hinge may be in rotatable communication with the first ground frame arm, the first support arm, the second support arm, the second ground frame arm, the second leg, and optionally with one or more than one intermediate support arm. Additionally disclosed may be a draw member, the draw member may be connected to the first ground frame arm. Additionally disclosed may be a plurality of fire panels made of fire-resistant material and connected together to form a fire cover therein, the fire cover may be reversibly attached to the frame.

### BRIEF DESCRIPTION OF THE DRAWINGS

Further advantages of the present disclosure may become apparent to those skilled in the art with the benefit of the following detailed description of the preferred embodiments and upon reference to the accompanying drawings in which:

FIG. 1 is a front perspective view of an assembly in accordance with one non-limiting embodiment for facilitating fire, flame, plasma, and ember protection of property in a ready to deploy configuration;

FIG. 2 is a front perspective view of an assembly in accordance with one non-limiting embodiment for facilitating fire, flame, plasma, and ember protection of property in a partially deployed configuration;

FIG. 3 is a front perspective view of an assembly in accordance with one non-limiting embodiment for facilitating fire, flame, plasma, and ember protection of property in a deployed configuration;

FIG. 4 is a perspective view of an assembly in accordance with one non-limiting embodiment for facilitating fire, flame, plasma, and ember protection of property illustrating internal framing structure and general outline of a fire cover;

FIG. 5 is a perspective view of an assembly in accordance with one non-limiting embodiment for facilitating fire, flame, plasma, and ember protection of property illustrating internal framing structure and general outline of a fire cover;

FIG. 6 is a top side plan view of an assembly in accordance with one non-limiting embodiment for facilitating fire, flame, plasma, and ember protection of a human body in a ready to utilize configuration;

FIG. 7 is a top side plan view of an assembly in accordance with one non-limiting embodiment for facilitating fire, flame, plasma and ember protection of a human body in a protective enveloped configuration;

FIG. 8 is a perspective view of an assembly in accordance with one non-limiting embodiment for facilitating fire, flame, plasma, and ember protection of a human body in a ready to utilize configuration; and,

FIG. 9 is a top side plan view of an assembly in accordance with one non-limiting embodiment for facilitating fire, flame, plasma, and ember protection of a human body in a ready to utilize configuration.

### DESCRIPTION OF THE VARIOUS PREFERRED EMBODIMENTS

Referring now to the drawings, like reference numerals designate identical or corresponding features throughout the several views. Further, described herein are certain non-limiting embodiments of a fire protection enclosure 100 for personal property protection and for bodily protection.

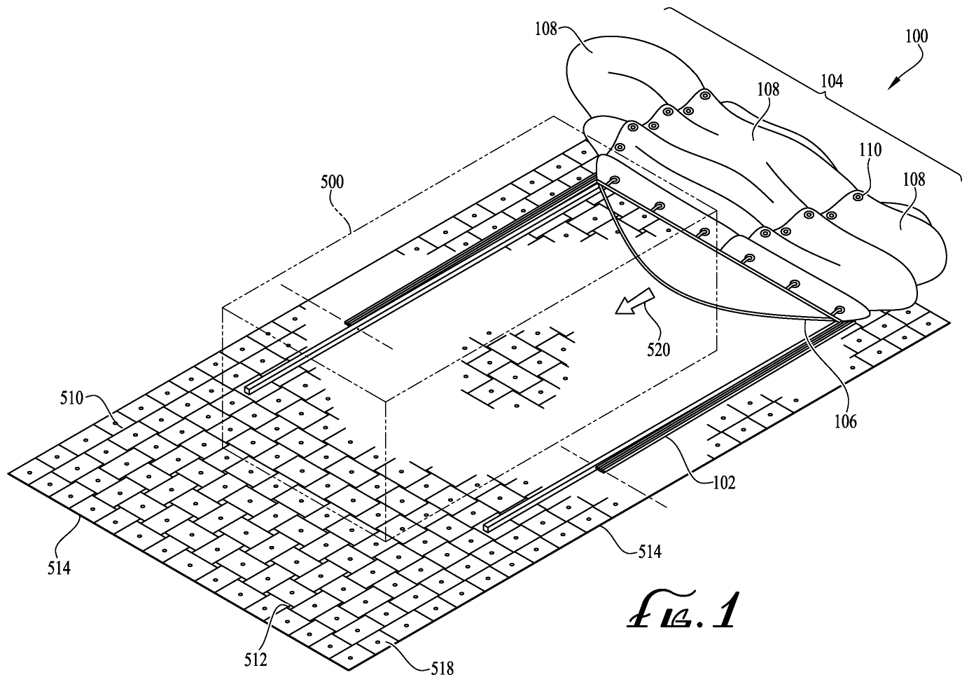

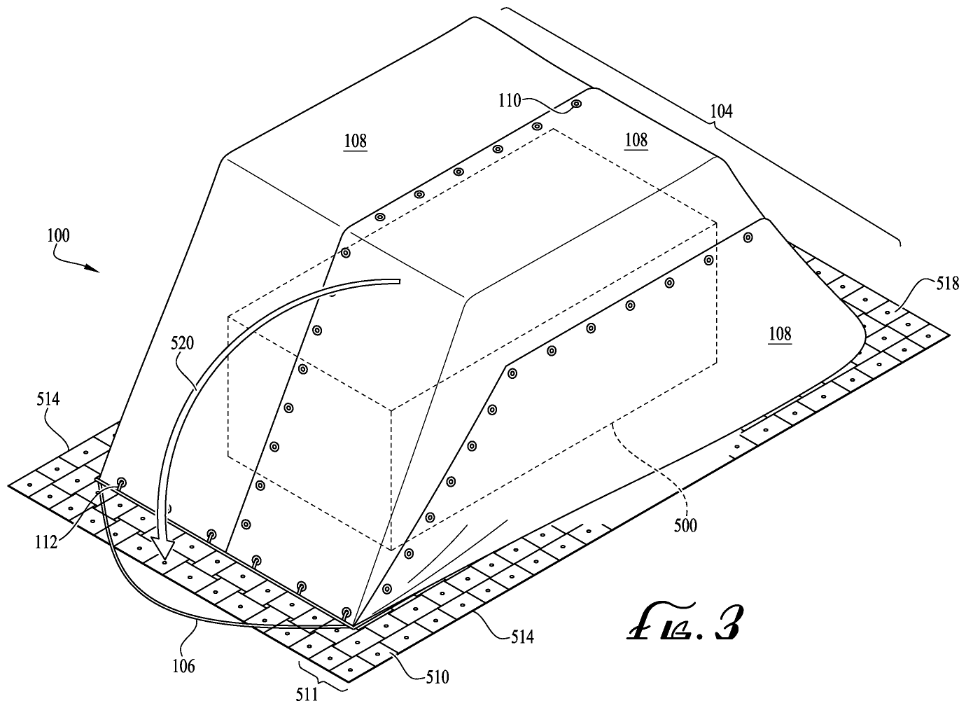

Shown in FIG. 1 is a fire protection enclosure 100 for an article or object 500. Object 500 may be that of personal property, personal belongings, vehicles, or small structures. Relevant components of the fire protection enclosure 100 include a frame 102, a fire cover 104, a pull rope 106, and a fire suppression blanket 510. The object 500 and frame 102 may be placed with respect to the fire suppression blanket such that the fire suppression blanket forms a fire defensible perimeter around the frame 102 and object 500. The fire suppression blanket 510 may span entirely under the frame 102, but is not required to. A fire defensible perimeter 511 (for example, as shown in FIG. 3) may be defined as being a sufficient length of the fire suppression blanket 510 extended in an outward direction, along all 4 sides, from the fire cover 104, such that a fire may be efficiently reduced in intensity on approach to the fire cover 104. The stated sufficient length may be a range of 3 inches to 5 feet. The pull rope 106 may be pulled in a direction indicated by direction arrow and indicates a deployment direction 520. The fire cover 104 may be constructed of a multiplicity of fire cover panels 108 and held together with fasteners 110. Together, the fire panels 108 are used to construct the fire cover 104. The fasteners may be any fastener used for the purposes of fire protection and able to withstand a large temperature gradient, for example, metal grommets, rivets, or similar type fastener.

As illustrated in FIG. 1, object 500 may be approximately centrally placed onto the fire suppression blanket 510. Alternatively, the object 500 and frame 102 may be placed with respect to the fire suppression blanket such that the fire suppression blanket forms a fire defensible perimeter around the frame 102 and object 500 when it is not feasible to place an object 500 on top of the fire suppression blanket 510. The fire suppression blanket 510 may span entirely under the frame 102, but is not required to. The fire suppression blanket 510 may be comprised of a lattice with multiple strips 518 of fire protective materials. The fire suppression blanket 510 may have openings 512 located between strips 518 which vary in size. Openings 512 towards a front edge 514 of the fire suppression blanket 510 may be larger in size than openings 512 located towards a middle portion 516 of the fire suppression blanket 510. This design may facilitate the rapid smothering of a fire as it moves from the front edge 514 of the fire suppression blanket 510 to the middle portion 516.

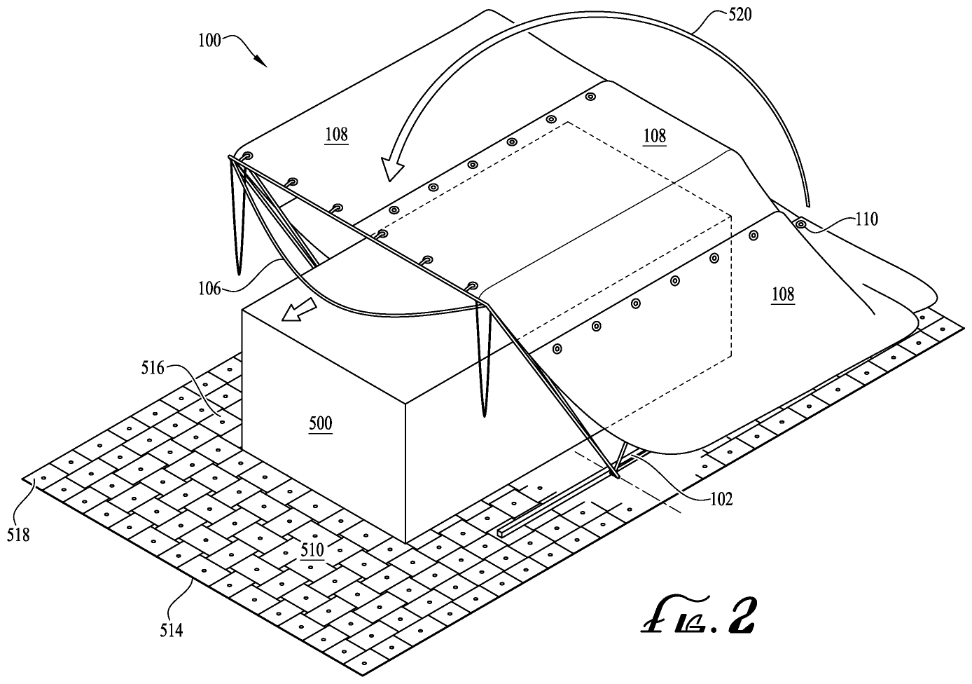

Shown in FIG. 2 are all the preceding elements and a further illustration of the direction of deployment of the fire protection enclosure 100. Indicated and continued from FIG. 1, is the pull direction 520 to enable fire protection and enclosure of an article or object 500. The object 500 may be an article that is owned by any individual or any article which may not be property but may nonetheless require full fire protection from a fire protection enclosure 100. Accordingly, the fire protection enclosure 100 may be constructed to enclose a wide variety of objects and may be custom sized to enclose any item which may be required to be protected from fire damage, for example, a car, a boat, a structure, a bicycle, furniture, precious flora, or any number of other objects.

Shown in FIG. 3 is the full deployment of the fire protection enclosure 100 with the relative position of the article of object 500 indicated internally. When fully deployed, the fire protection enclosure 100 creates two zones, the protected or enveloped area, and the external area prone to fire. One potential intent of the fire protection enclosure is to limit or prevent the external area from harming the internal enveloped zone. While not illustrated, a user of the fire protection enclosure 100 may utilize heavyweights to hold the sides of the fire cover 104 down, by way of example only, the use of chains, bricks, or other metal or stone objects. Further, the fire suppression blanket 510 may be manufactured in strips of a width sufficient to form a fire defensible perimeter as seen in FIG. 3. This may be especially valuable when a structure requires the fire protection.

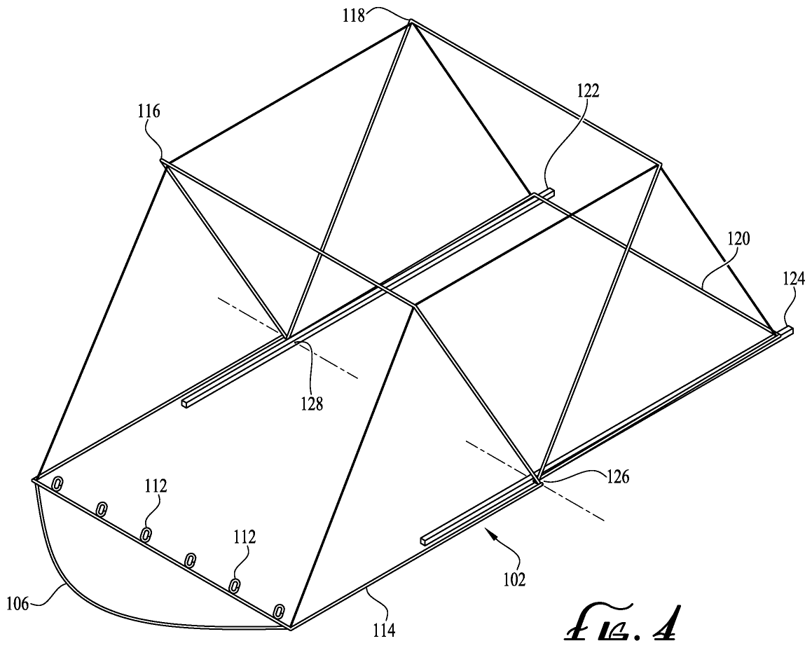

Still referring to FIG. 3, the frame 102 (for example, as shown in FIGS. 1 and 4) supports the multiplicity of fire panels 108, and together form a full sheet comprising the fire cover 104 and therefore offers protection to the internal article of object 500 (illustrated in broken lines under fire cover 104). A multiplicity of fastener links 112 are shown on the edge of the fire protection enclosure 100. The fastener links 112 couple the multiplicity of fire panels 108 to the front portion of the frame 102. The fastener links may be of any material sufficient to withstand a high-temperature gradient as may be experienced by a fire. The coupling enables the fire cover 104 to move with the frame 102 during deployment of the fire protection enclosure 100. Further, a defensible perimeter 511 is indicated as a boundary around the fire protection enclosure 100. As was previously noted, the defensible perimeter 511 may be anywhere between 3 inches to 5 feet in length from the edge of the fire cover 104. While the defensible perimeter 511 is shown on one side only, it should be understood that all four sides of the fire protection enclosure 100 may include the defensible perimeter 511.

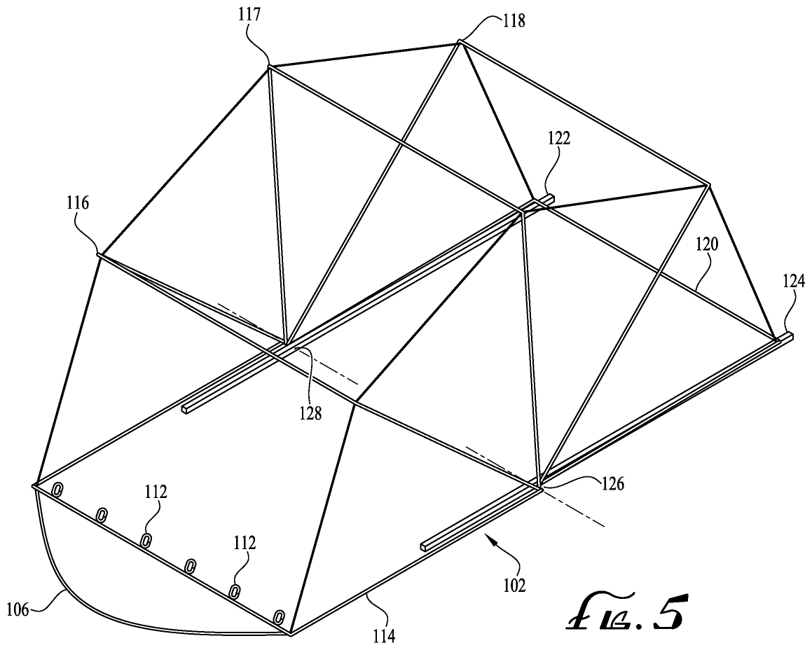

FIGS. 4 and 5 show the frame 102 as it relates to the outline of the fire cover 104 (for example, as shown in FIG. 3). The frame portions include a first ground frame arm 114, a first support arm 116, second support arm 118, a second ground frame arm 120, a first leg 122, and a second leg 124. The first ground frame arm 114 and the second ground frame arm 120 work in tandem to maintain contact between the ground and the fire cover 104. The first support arm 116 and the second support arm 118 work in tandem to support the tent-like shape of the fire protection enclosure 100. The first leg 122 and the second leg 124 may enable the fire protection enclosure 100 to remain stable on the ground while deployment is occurring. Further, the first leg 122 and second leg 124 may have a multiplicity, at least two, of hinge 126. For clarity, a first hinge 128 and a second hinge 126 may be disclosed, and either or both the first hinge 128 and the second hinge 126 may allow for the first ground frame arm 114, the second ground frame arm 120, the first support arm 116, and the second support arm 118 to pivot up and over the internal article of object 500 (for example, as shown in FIGS. 1-3). FIG. 5 additionally shows an intermediate support arm 117. The intermediate support arm 117 may be replicated to make the fire protection enclosure 100 longer and/or larger. There may be a multiplicity of intermediate support arm 117 located between the first support arm 116 and the second support arm 118.

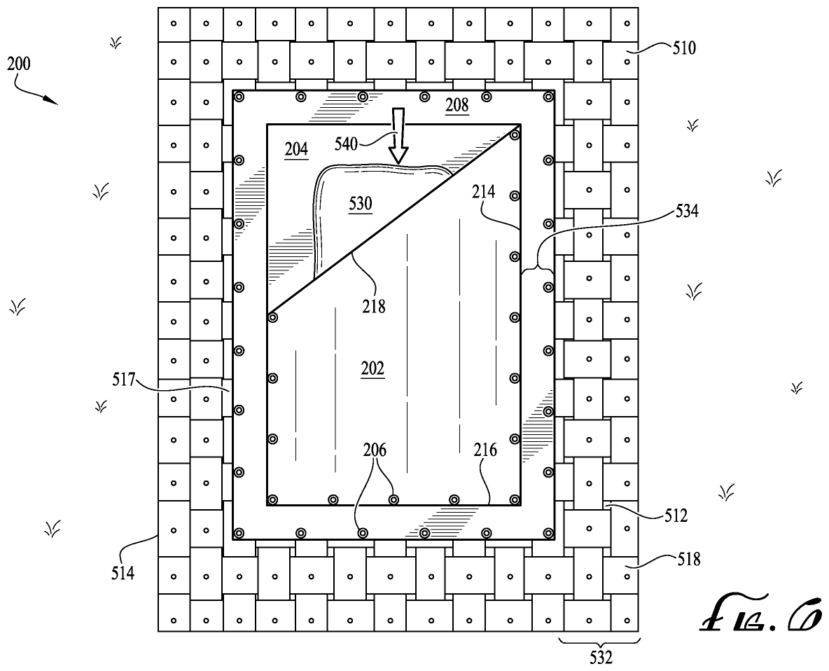

Shown in FIG. 6 is personal protection enclosure 200. Personal protection enclosure 200 may have an upper portion 202 and a lower portion 204 wherein an entry 212 may be defined. The personal protection enclosure 200 may be designed for use in tandem with a personal fire shelter 530 commonly known to the art and used by hotshot crews fighting wildfires. The personal protection enclosure 200 may hold a personal fire shelter 530 between the lower portion 204 and the upper portion 202, such that the personal fire shelter 530 may be sandwiched between the two portions. The upper portion 202 and the lower portion 204 may be fastened by fastener 206 commonly known and used in the industry, for example, rivets, grommets, or other thermally resistant fasteners.

Still referring to FIG. 6, shown is a fire suppression blanket 510 around the personal protection enclosure 200. This embodiment of the fire suppression blanket 510 may have a front edge 514 and back edge 517. The front edge 514 may be defined as the perimeter of the fire suppression blanket 510 and may be positioned such that a front edge 514 is closest to an oncoming fire. The fire suppression blanket 510 may comprise a lattice structure and made of strips 518. There may be openings 512 between the strips 518 which are larger in size closer to the front edge 514 and smaller in size towards the back edge 517. The upper portion 202 may have one long side 214, two short sides 216, and one angled side 218.

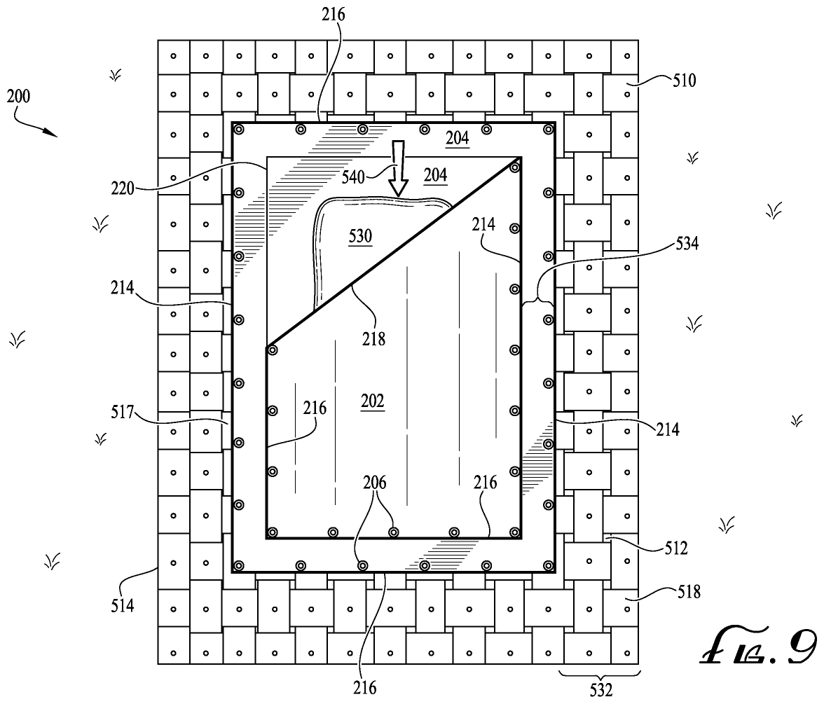

FIG. 6 further shows that the fire suppression blanket 510 may or may not be attached to the personal protection enclosure 200 by use of a coupling strip 208 that may be fastened to the edge of the personal protection enclosure 200. The coupling strip 208 may be fastened to the upper portion 202, the lower portion 204, or in between the upper portion 202 and the lower portion 204. Fastened to the coupling strip 208 with fastener 206 may be the fire suppression blanket 510 that acts to suppress active fire around the perimeter of the personal protection enclosure. The use of a coupling strip 208 may not be required as the lower portion 204 may be extended beyond the upper portion 202 (for example, as illustrated in FIG. 9). Use of fire suppression blanket 510 surrounding the personal fire protection enclosure 200 may ensure that active plasma from the fire or embers do not get too close to individuals sheltering internally to the personal protection enclosure 200. Entry into the personal protection enclosure 200 is indicated by entry direction 540 arrow. There may be two distances which are relevant, a fire suppression blanket span 532 and a skirt span 534. The fire suppression blanket span 532 should be sufficient to initiate a smothering of oncoming fire, while the skirt span 534 should be sufficient to form a cooled zone which may drive airflow upwards through circumvention. The fire suppression blanket span 532 and the skirt span 534 are not predetermined and may be altered for a specific need and/or task. The fire suppression blanket span 532 may occur on both the personal fire protection enclosure 200 and the fire protection enclosure 100.

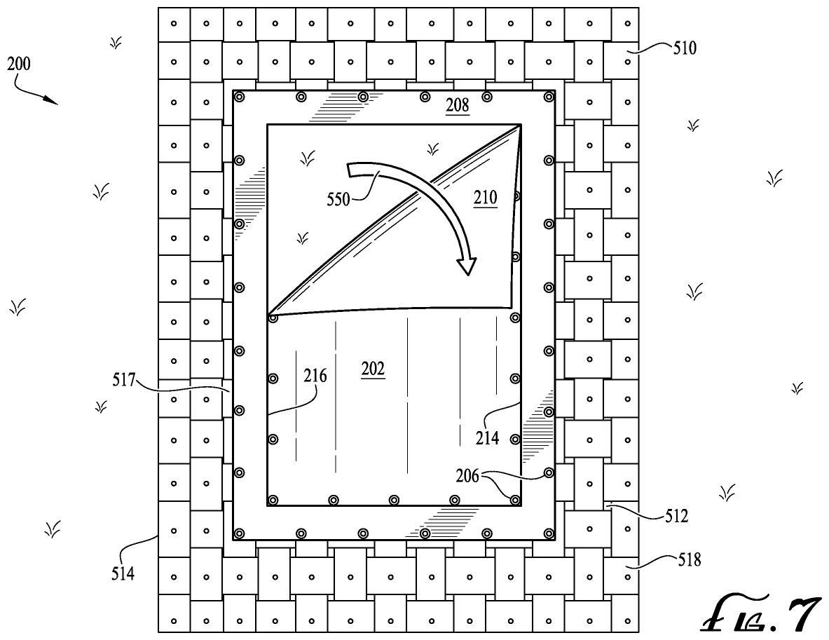

FIG. 7 shows all the preceding elements indicated in FIG. 6 with the additional information indicated by fold direction 550 arrow. Subsequent to personal entry via fold direction 550 into the personal protection enclosure 200, an individual then folds a corner of the lower portion 204, a fold flap 210, over the top of the upper portion 202 such that a closed envelop type structure is created. In this way, a person who is internal to the personal protection enclosure is protected from the active plasma of a flame and embers resulting from an active fire. When fully deployed, the personal protection enclosure 200 creates two zones, the protected or enveloped area, and the external area prone to fire. One potential intent of the personal protection enclosure is to limit or prevent the external area from harming the internal enveloped zone. The fold flap 210 may be held in a folded configuration, for example, with high-temperature hook and loop fasteners, with magnetic seals, with snap connectors, or other fasteners that are suitable to the application.

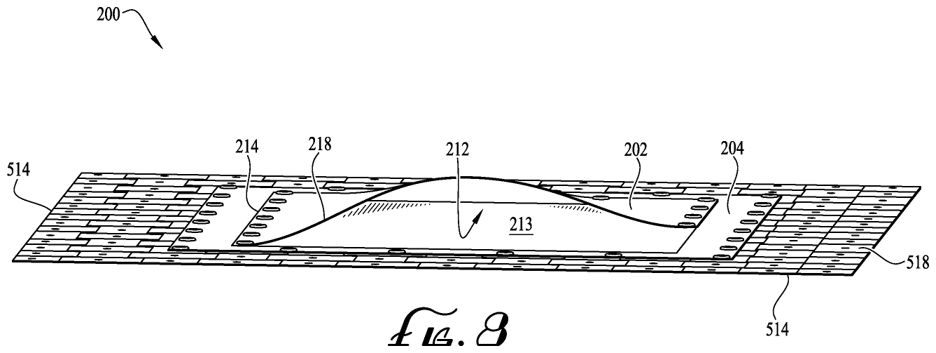

FIG. 8 illustrates a perspective view wherein the viewer is looking down the entry direction 540 (for example, as shown in FIG. 6) and into the entry 212 as though a user of the personal fire protection enclosure 200 were to be readying to enter. As noted, the combination of the upper portion 202 over the lower portion 204 may define the entry 212. The entry 212 may lead to cavity 213. Once a user has entered the entry 212, the fold flap 210 may be folded over (for example, as illustrated in FIG. 7) and closed off to an oncoming fire and secured in the cavity 213.

FIGS. 8 and 9 are also illustrated for additional embodiments of the lower portion 204, wherein the lower portion 204 is shown as extended beyond the two short side 216 and the long side 214 of the upper portion 202. This embodiment is illustrated as being without the coupling strip 208. Accordingly, the coupling strip 208 has been replaced with the oversized lower portion 204 therein eliminating the need for the coupling strip 208. The elimination of the coupling strip 208 has given rise to the need to define a fold cut 220. The fold cut 220 may be a pre-cut section of the lower portion 204 such that the fold-over of the fold flap 210 may still occur. Where a coupling strip 208 is used, for example in FIG. 6, the fold cut 220 may not be necessary.

Having disclosed the structure of the preferred embodiments, it is now possible to describe its function, operation, and use. At each point wherein two sheets of fire-resistant material come together to form a continuous sheet, or at any point wherein fasteners 110 or fasteners 206 may be used, the fire-resistant materials may be further glued to aid in the fire protection properties of the fire protection enclosure 100 or the personal protection enclosure 200.

The fire protection enclosure 100 and the personal protection enclosure 200 may be reusable, durable, and able to withstand high-intensity heat from wildfire or uncontrolled residential fire. Each may be rapidly deployable and used within moments of learning of impending fire hazard.

One contemplated method of deploying the fire protection enclosure 100 is for an individual to notice or become notified of a fire risk, place objects requiring fire protection approximately centered to fire suppression blanket 520, pull on pull rope 106 in the direction indicated by deployment direction 520 arrow, continue pulling on pull rope 106 until first ground frame arm 114 is in contact with the ground, then evacuate the area.

One contemplated method of deploying personal protection enclosure 200 is for an individual to travel to an area prone to burning with the personal protection enclosure 200. Upon notice or notification of impending fire hazard, an individual may place personal protection enclosure 200 on the ground with upper portion 202 positioned above the lower portion 204. The person may ensure that surrounding fire suppression blanket 510 is flat. The individual may already have personal fire shelter 530 internal to personal protection enclosure, if the personal fire shelter 530 is not all ready internal, then the person would then place personal fire shelter 530 internal to the personal protection enclosure 200. The person would then enter the personal fire shelter 530, which is internal to the personal protection shelter 200 by direction indicated by entry direction 540. The person would then fold or close personal protection shelter 200 by fold direction 550.

Personal protection enclosure 200 is contemplated to be closed by way of a number of methods, including but not limited to, allowing gravity to maintain the fold direction 550, using a high-temperature hook and loop closure for fold direction 550 along the edges of the fold, or using a drawstring method of maintaining fold direction 550.

The fire suppression blanket 510 may be used for fighting grass and scrub fire along a fire line and protection of objects 500 and people. The fire suppression blanket 510 may constitute a sheet made of fire-resistant material having a lattice. The lattice may be defined as having a multiplicity of openings 512. The openings 512 may vary in size from larger openings 512 along a front edge 514 of the sheet to smaller openings 512 toward an opposing back edge 516 of the lattice. The openings 512 may vary in size between larger openings and smaller openings approximately parallel to the fire line for dividing the fire into multiple smaller fires. The openings may be configured in a parabolic shape open toward the front edge of the sheet, the parabolic shape forming a burn zone of the sheet. Additionally, the fire suppression blanket 510 may be constructed of a sheet made of fire-resistant material. The fire-resistant material of the sheet may be formed as a lattice defining a multiplicity of openings 512. The lattice may be formed by strips 518 of fire-resistant material.

Additionally disclosed herein may be that of a personal fire protection enclosure 100 which may comprise a fire suppression blanket 510 made of fire-resistant material. The fire suppression blanket 510 may have a lattice that may define a multiplicity of openings 512. An upper portion may further have one long side 214, two short sides 216, an angled side 218, and similarly be made of fire-resistant material. Further disclosed may be a lower portion 204 having two long sides 214 and two short sides 216 and may likewise be made of fire-resistant material. The lower portion may further have a fold flap 210. A coupling strip 208 may or may not be used, but the coupling strip 208 may be adapted to connect the fire suppression blanket 510 to the lower portion 204 if so used.

Additionally disclosed herein may be that of a personal fire protection enclosure 100 which may further have a fire suppression blanket 510 which may be made of fire-resistant material. The fire suppression blanket 510 may further have a lattice which may define a multiplicity of openings 512. Said openings 512 may vary in size from larger openings 512 along a front edge 514 of the fire suppression blanket 510 to smaller openings 512 toward a back edge 517 of the fire suppression blanket 510. Further disclosed may be that of an upper portion 202 which may have one long side 214, two short sides 216, an angled side 218, and may further be made of fire-resistant material. Further disclosed may be that of a lower portion 204 which may have two long sides 214, two short sides 216, a fold cut 220, and may be made of fire-resistant material and further having a fold flap. The upper portion 202 may be fastened to the lower portion 204 along the one long side 214 and the two short sides 216 of the upper portion 202 which may define an entry 212. Said entry 212 may be additionally defined along the angled side 218 of the upper portion 202. The entry 212 may lead to a cavity 213 between the upper portion 202 and the lower portion 204. Optionally, a coupling strip 208 may be adapted to connect the fire suppression blanket 510 to the lower portion 204. The entry 212 and the cavity 213 may define an entry direction 540. Said entry direction 540 may therein define a path to entry 212 for a human body. The fold flap 210 may be further adapted to fold over the upper portion 202 such that the human body is completely enclosed within the cavity 213.

Further, certain methods of using a personal fire protection enclosure 200 may be disclosed by indicating the steps of placing a personal fire protection enclosure 200 on the ground, orienting the personal fire protection enclosure 200 such that an upper portion 202 is on top and a fire suppression blanket 510 surrounds the perimeter, navigating a human body through an entry 212 by using an entry direction 540 until a user is under the upper portion 202 and above a lower portion 204, and then pulling a fold flap 210 over the top of the upper portion 202 such that the entry 212 is closed.

Certain embodiments of a fire protection enclosure 100 may be disclosed where the fire protection enclosure 100 may comprise a fire suppression blanket 510 made of fire-resistant material. The fire suppression blanket 510 may have a lattice which defines a multiplicity of openings 512. The fire protection enclosure 100 may further have a frame 102 which may have a first hinge 128, a second hinge 126, a first ground frame arm 114, a first support arm 116, a second support arm 118, a second ground frame arm 120, a first leg 122, and a second leg 124 and may optionally include an intermediate support arm 117. There may be any number of intermediate support arm 117 present or not present, dependent on the specific environment of use. The first hinge 128 may be in rotatable communication with the first ground frame arm 114, the first support arm 116, the second support arm 118, the second ground frame arm 120, the first leg 122, and optionally with one or more than one intermediate support arm 117. The second hinge 126 may be in rotatable communication with the first ground frame arm 114, the first support arm 116, the second support arm 118, the second ground frame arm 120, the second leg 124, and optionally with one or more than one intermediate support arm 117. Additionally disclosed may be a draw member 106, the draw member 106 may be connected to the first ground frame arm 114. Additionally disclosed may be a plurality of fire panels 108 made of fire-resistant material and connected to form a fire cover 104 therein, the fire cover 104 may be reversibly attached to the frame.

Certain additional embodiments of a fire protection enclosure 100 may be disclosed where the fire protection enclosure 100 may comprise a fire suppression blanket 510 made of fire-resistant material. The fire suppression blanket 510 may have a lattice which defines a multiplicity of openings 512. The openings 512 may vary in size from larger openings along a front edge 514 of the fire suppression blanket 510 to smaller openings 512 toward a middle portion 516 of the fire suppression blanket 510. A frame 102 may be configured to be placed on top and centrally to the fire suppression blanket 510. Alternatively, the object 500 and frame 102 may be placed with respect to the fire suppression blanket such that the fire suppression blanket forms a fire defensible perimeter around the frame 102 and object 500. The fire suppression blanket 510 may span entirely under the frame 102, but is not required to. The frame may have a first hinge 128, a second hinge 126, a first ground frame arm 114, a first support arm 116, a second support arm 118, a second ground frame arm 120, a first leg 122, a second leg 124, and optionally one or more than one intermediate support arm 117 placed between the first support arm 116 and the second support arm 118. Further, the first hinge 128 may be in rotatable communication with the first ground frame arm 114, the first support arm 116, the second support arm 118, the second ground frame arm 120, the first leg 122, and optionally one or more than one intermediate support arm 117 placed between the first support arm 116 and the second support arm 118. Further, the second hinge 126 may be in rotatable communication with the first ground frame arm 114, the first support arm 116, the second support arm 118, the second ground frame arm 120, the second leg, optionally one or more than one intermediate support arm 117 placed between the first support arm 116 and the second support arm 118. A draw member 106 may be further utilized. The draw member 106 may be connected to the first ground frame arm 114. A plurality of fire panels 108 may be further utilized and made of fire-resistant material. Said fire panels 108 may be connected to form a fire cover 104 therein. The fire cover 104 may be attached to the frame 102 such that when the draw member is pulled in a deployment direction 520 the first ground frame arm 114 may hingedly lift up and over an object 500 placed onto of the fire suppression blanket 510 wherein the fire cover 104 may completely envelop the object and be supported by the frame.

Certain methods of protecting an object 500 from a fire may be disclosed by the steps of placing an object 500 and frame 102 with respect to the fire suppression blanket such that the fire suppression blanket forms a fire defensible perimeter around the frame 102 and object 500. Orienting the object 500 between a first leg 122 and a second leg 124 of a frame 102 and approximately central to the fire suppression blanket 510 and/or the fire defensible perimeter. Pulling a draw member 106 in a deployment direction 520 such that when the draw member 106 is pulled in the deployment direction 520 a first ground frame arm 114 hingedly lifts up and over the object 500 and, then guiding the first ground frame arm 114 to ground such that the object 500 is completely enveloped by a fire cover 104.

For convenience, a complete reference listing for the figures are as follows:
fire protection enclosure 100
frame 102
fire cover 104
draw member 106
fire panels 108
fasteners 110
fastener links 112
first ground frame arm 114
first support arm 116
intermediate support arm 117
second support arm 118
second ground frame arm 120
first leg 122
second leg 124
second hinge 126
first hinge 128
personal fire protection enclosure 200
upper portion 202
lower portion 204
coupling strip 208
fold flap 210
entry 212
cavity 213
long side 214
short side 216
angled side 218
fold cut 220
object 500
fire suppression blanket 510
openings 512
front edge 514
middle portion 516
back edge 517
strips 518
deployment direction 520
fire suppression blanket span 532
skirt span 534
personal fire shelter 530
entry direction 540
fold direction 550

While various embodiments of the disclosure have been illustrated and described, it is not intended that these embodiments illustrate and describe all possible forms. Rather, the words used in the specification are words of description rather than limitation, and it is understood that various changes may be made without departing from the spirit and scope of this disclosure.

Accordingly, it is not intended that this disclosure be limited except by the appended claims. Insofar as the description above and the accompanying drawings disclose any additional subject matter that is not within the scope of the claims below, the various embodiments are not dedicated to the public and the right to file one or more applications to claim such additional embodiments is reserved.

What is claimed is:

1. A fire protection enclosure, comprising:
a fire suppression blanket made of fire resistant material, the fire suppression blanket having a lattice defining a multiplicity of openings;
a frame having a first hinge, a second hinge, a first ground frame arm, a first support arm, a second support arm, a second ground frame arm, a first leg, and a second leg;
the first hinge being in rotatable communication with the first ground frame arm, the first support arm, the second support arm, the second ground frame arm, and the first leg;
the second hinge being in rotatable communication with the first ground frame arm, the first support arm, the second support arm, the second ground frame arm, and the second leg;
a draw member, the draw member being connected to the first ground frame arm; and,
a plurality of a fire panels made of fire resistant material and connected together to form a fire cover therein, the fire cover reversibly attached to the frame.

2. The fire protection enclosure of claim 1 wherein the lattice is formed by woven strips of fire resistant material.

3. The fire protection enclosure of claim 1 wherein the fire resistant material is fiberglass coated in vermiculite.

4. The fire protection enclosure of claim 1 wherein the fire panels are connected together by a plurality of fasteners and the fire cover is further connected to the frame by a plurality of fasteners.

5. The fire protection enclosure of claim 1 wherein the multiplicity of openings of the fire suppression blanket are oriented such that a larger openings are disposed along a front edge of the fire suppression blanket and a smaller openings are disposed toward a middle of the fire suppression blanket.

6. The fire protection enclosure of claim 1 wherein the frame is configured to be placed with respect to the fire suppression blanket such that the fire suppression blanket forms a fire defensible perimeter around the frame and further configured to protect an object placed between the first leg and the second leg.

7. The fire protection enclosure of claim 1 wherein the draw member is adapted such that when the draw member is pulled in a deployment direction the first ground frame arm hingedly lifts up and over the object, the fire cover completely enveloping the object and supported by the frame.

8. The fire protection enclosure of claim 1 wherein one or more than one intermediate support arms are disposed between the first support arm and the second support arm to lengthen the frame.

9. A fire protection enclosure, comprising:
a fire suppression blanket made of fire resistant material, the fire suppression blanket having a lattice defining a multiplicity of openings;
wherein the openings vary in size from a larger openings along a front edge of the fire suppression blanket to a smaller openings toward a middle of the fire suppression blanket;
a frame configured to be placed with respect to the fire suppression blanket such that the fire suppression blanket forms a fire defensible perimeter, the frame having a first hinge, a second hinge, a first ground frame arm, a first support arm, a second support arm, a second ground frame arm, a first leg, and a second leg;
the first hinge being in rotatable communication with the first ground frame arm, the first support arm, the second support arm, the second ground frame arm, and the first leg;
the second hinge being in rotatable communication with the first ground frame arm, the first support arm, the second support arm, the second ground frame arm, and the second leg;
a draw member, the draw member being connected to the first ground frame arm; and,
a plurality of fire panels made of fire resistant material and connected together to form a fire cover therein, the fire cover attached to the frame such that when the draw member is pulled in a deployment direction the first ground frame arm hingedly lifts up and over an object, the fire cover completely enveloping the object and supported by the frame.

10. The fire protection enclosure of claim 9 wherein the lattice is formed by woven strips of fire resistant material.

11. The fire protection enclosure of claim 9 wherein the fire resistant material is fiberglass coated in vermiculite.

12. The fire protection enclosure of claim 9 wherein the fire panels are connected together by a plurality of fasteners, and the fire cover is connected to the frame by a plurality of fasteners.

13. The fire protection enclosure of claim 9 wherein the front edge of the fire suppression blanket is oriented towards a fire and the back edge of the fire suppression blanket is oriented towards the frame.

14. The fire protection enclosure of claim 9 wherein one or more than one intermediate support arms are disposed between the first support arm and the second support arm to lengthen the frame.

15. A method of protecting an object from a fire comprising the steps of:
placing a frame with respect to a fire suppression blanket such that the fire suppression blanket forms a fire defensible perimeter around the frame;
orienting an object between a first leg and a second leg of the frame;
pulling a draw member in a deployment direction such that when the draw member is pulled in the deployment direction a first ground frame arm hingedly lifts up and over the object; and,
guiding the first ground frame arm to a ground such that the object is completely enveloped by a fire cover.
